(19) United States
(12) Patent Application Publication
(10) Pub. No.: US 2008/0107127 A1
(43) Pub. Date: May 8, 2008

(54) Aggregation of Inter-Domain Resource Signaling

(76) Inventors: Thomas Engel, Unterbiberg (DE); Thomas Schwabe, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/792,544

(22) PCT Filed: Dec. 7, 2005
(86) PCT No.: PCT/EP05/56550

§ 371 Date: Jun. 7, 2007

(30) Foreign Application Priority Data
Dec. 7, 2004 (DE) 102004058927.5

(51) Int. Cl. H04B 7/212

(52) U.S. Cl. 370/443

(57) ABSTRACT

A method for aggregating or combining signaling messages for the adaptation of resource reservations required for route modifications is provided. According to the method, a modification of an inter-domain route requiring an adaptation of resource reservations is disclosed to a first routing domain. The first routing domain communicates the modification of the inter-domain route to at least a second and a third routing domain. Resource reservations adapted according to the route modification are then disclosed by the second and the third routing domains to the first routing domain and are combined in order to be transferred to a fourth routing domain. According to one form of embodiment, a timer is used to define the period of time for combining reservation messages, in order to be able to transfer modified reservations in a more efficient manner.

### CROSS REFERENCE TO RELATED APPLICATIONS

This application is the US National Stage of International Application No. PCT/EP2005/056550, filed Dec. 7, 2005 and claims the benefit thereof. The International Application claims the benefits of German application No. 102004058927.5 DE filed Dec. 7, 2004, both of the applications are incorporated by reference herein in their entirety.

### FIELD OF INVENTION

The invention relates to a method and a device for the efficient adaptation of resource reservations when routes are modified in inter-domain routing.

### BACKGROUND OF INVENTION

High demands are placed on the routing between different networks, inter-domain routing, and the signaling required for this, these demands are particularly high where a large number of networks interact as part of a network system during an end-to-end transmission and at the same time quality criteria must be guaranteed for the transmission. The most important example for such a scenario is the transmission of real-time traffic via the Internet based on the IP protocol.

In future IP networks will also support applications, which include the transmission of voice, video and data streams, which will require a fast and reliable transport of IP packets. The aim of the current development work is that future IP networks, in addition to providing the traditional “best effort” service, provide new transmission services, which make the required bandwidths continuously available to the traffic and transmit the IP packets reliably to the recipient with slight, hardly varying delay and very low packet loss rates. A network that is equipped to realize these new transmission services, is also called an NGN (Next Generation Network). Traffic that is transported as part of this service is also called QoS traffic (QoS: Quality of Service).

Today's Internet is a combination of a growing number of individual IP networks, so-called autonomous systems (AS) or routing domains that are managed and controlled by different organizations. The Internet currently consists of more than 15,000 autonomous systems. Similarly, in the future NGNs will be combined to form a network system and QoS services offered cross-network.

In order to be able to offer QoS services, the resources required for this must be reserved not only within an NGN but also on the links between the NGNs. For this there are currently two proposals for an inter-domain resources signaling protocol, the Border Gateway Reservation Protocol (BGRP, Pan, P., E. Hahne, H. Schulzrinne: “BGRP: Sink-Tree-Based Aggregation for Inter-Domain Reservations”, Journal of Communications and Networks, Vol. 2, No. 2, pp. 157-167, June 2000) and the Shared-segment Inter-domain Control Aggregation Protocol (SICAP, R. Sofia, R. Guerin and P. Veiga: “SICAP, a Shared-segment Inter-domain Control Aggregation Protocol”, High Performance Switching and Routing, HPSR 2003, Turin, Italy, June 2003). The two protocols differ mainly in their aggregation behavior.

In this context, aggregation is understood as the combination of reservations for different QoS traffic streams, i.e. of individual links or of smaller aggregates, to form a common reservation. The traffic streams combined with the aggregation of reservations then form an aggregate for which furthermore only one single reservation has to be managed. With BGRP all reservations to one destination are combined. SICAP still also aggregates on intermediate segments of the end-to-end paths.

The aggregation of inter-domain reservations is necessary to limit the number of the reservations required for QoS traffic between the very large number of different autonomous systems in such a way that they can be transmitted and processed in suitable time with reasonable use of computational and memory capacity. If the route to a destination is modified, then the aggregates of the QoS traffic that will be transported via the modified route must be deaggregated, as the route modification can cause aggregates to lose their validity. After route modifications, the traffic streams that previously formed an aggregate, can travel via different routes and hence require new aggregates. A route modification can be caused by the failure of a link or overload on the link used. In order to deaggregate the aggregates, messages are sent to all participating sources and those concerned must adapt their reservations to the new routes.

### SUMMARY OF INVENTION

An object of the invention is to specify a method which is less complex and efficient in respect of the signaling load for adapting resource reservations when routes are modified within the context of inter-domain routing.

According to the invention, in the case of a route cancellation and the traffic transfer or diversion caused by this, it is proposed to combine resource-reservations in order to create the most efficient signaling possible.

In the course of the invention when a route is modified within the context of inter-domain routing, a modification of an inter-domain route (this can be the withdrawal of an inter-domain route or the disclosure of a modified inter-domain route), which modification requires an adaptation of resource-reservations, is communicated to a first routing domain. The first routing domain then communicates this modification, for example in the form of a route modification message (e.g. UPDATE message of the BGP protocol) to at least a second and a third routing domain, but preferably to all neighboring routing domains, from which QoS traffic was transported via the first routing domain along the route affected by the modification. A resource reservation adapted according to the route modification is signaled by the second and the third routing domain respectively to the first routing domain, which resource reservation requests, for example, resources along an alternative route or new route. These signaled or disclosed resource reservations are combined by the first routing domain and further communicated, normally to a fourth routing domain which originally communicated the route modification to the first routing domain.

The invention has the advantage that resource reservations are further communicated in combined form and so the use of signaling is optimized. When an aggregate is deaggregated and reconstructed, the number of signaling messages is thus greatly reduced.

The inventive method can result in a delay of resource reservations, if, for example, the resource reservation signaled by the second routing domain arrives with delay, as a result of which the transfer of the combination of the resource reservations by the routing domains two and three is delayed. In this case the resource reservation of the third routing domain also occurs with a delay, which would not have occurred without aggregation or combination of the reservations. Because of this problem, according to one form of embodiment it is proposed to introduce a timer or clock and only to combine resource reservations received while the timer is running. If all the resource reservations are received within the running time of the timer, then said reservations can be forwarded together (possibly even before the timer has run out). Otherwise only the resource reservations received while the timer was still running are forwarded in aggregated form. Resource reservations arriving later can then be further communicated as single reservations not aggregated or not combined.

It is expedient to disclose the routing modification from the first routing domain along existing inter-domain routes to the routing domains that have reserved resources along routes that lead to a shared destination via the first routing domain and are affected by the route modification. This produces a route tree of routes to which the route modification from the first routing domain is communicated. According to one embodiment of the subject matter of the application, in the reverse direction when passing through the tree with modified resource reservations in the routing domains that do not represent a “leaf node”, i.e. are not an end point, the resource reservations are aggregated in accordance with the invention. The shared destination or the root of a route tree or a multiplicity of routes, by which means is determined which route reservations can be combined, is given, for example, by a routing domain representing the end point of the routes. However, it is also conceivable that it is not a routing domain, but a network—e.g. defined by a specific address, which can form a part of a domain. Likewise the destination is not necessarily the end point of routes, but can also be a suitably selected intermediate point or a suitably chosen domain along a route. An aggregation of reservations related not just to the end points is also provided for, for example, in a different context to this application in the SICAP protocol.

The above embodiment of the subject matter of the invention can be advantageously extended, not only in the first routing domain, but also in other routing domains, to which the route modification is disclosed via the first routing domain and which do not form the end point of a route, by also starting a timer for the aggregation of resource reservations. Thus, for example, a timer can also be started in the second routing domain; preferably, however, timers are started in all routing domains that are informed about routing modification by the first domain and that as a result receive new resource reservations from more than one domain to the same destination.

If several timers are used, it is of advantage to synchronize the timers. Such a coordination is meant to achieve that, if a routing domain, which, once its timer has expired, combines the resource reservations received by then into one reservation and signals said resource reservations to a subsequent routing domain regarding the modified route, the timer of this routing domain has also not expired, so that the signaled (aggregated) route reservation can be aggregated or combined with further route reservations. It is therefore advisable to set the running time of a timer of a routing domain to be shorter than the running time of the timer of the routing domain to which then the aggregated route reservations are signaled.

In a preferred embodiment, the running time of the timers for all routing domains, which aggregate route reservations and work with timers to do so, is coordinated. One thus arrives at a kind of timer cascade or timer interval nesting, where the more one approaches the end points or leaf nodes in the route tree, the shorter the running time of the timer becomes. In general, the later a timer is started, the shorter the running time of a timer. The timers can be coordinated with each other by exchanging a piece of information, which is, for example, a component of the route modification message. This information can, for example, contain the running time of the timer, which can be used in conjunction with the message transmission duration, which is frequently already provided for in the protocol, e.g. in the form of a time stamp, in order to determine a suitable running time for the timer. Other solutions are also conceivable, for example, it is also possible to envisage that empirical values for a suitable timer running time are given according to the distance of the routing domain from the domain situated furthest forward in the tree. In this embodiment, for example, a domain that is situated in third place with respect to the routing domains using the timers, only needs to forward to a subsequent routing domain the information that said subsequent routing domain is situated in fourth place, so that it chooses the running time provided for this position.

The invention also comprises a device, e.g. a router, with means to carry out a method according to the invention.

### BRIEF DESCRIPTION OF THE DRAWINGS

The subject matter of the invention is explained in more detail below in an embodiment with reference to drawings, in which;

FIG. 1 shows routing domains with resource reservation aggregation for routing to a destination network N1.

FIG. 2 shows the routing domains shown in FIG. 1 with an aggregation, according to the invention, of new route reservations when there is a modification of the routes leading to the destination N1.

### DETAILED DESCRIPTION OF INVENTION

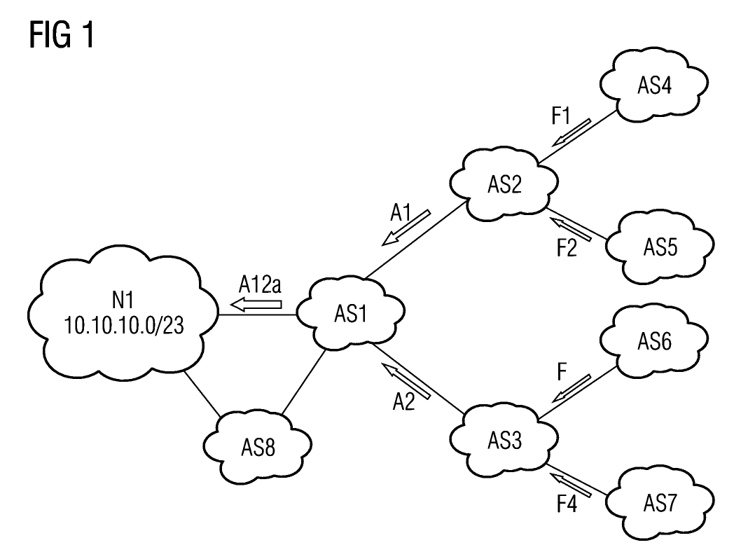

FIG. 1 shows the disadvantages of the method according to prior art. The basic process with respect to an aggregation and deaggregation in BGRP and SICAP is very similar and hence has the same problem as is solved in this application. For that reason only BGRP is considered in the following.

FIG. 1 shows an example of aggregation of reservations in accordance with BRGP. In the network system shown, each of the four autonomous systems AS4, AS5, AS6 and AS7 has established one reservation to the destination network N1. The reservations begin with the reservations Fl, F2, F3 and F4 between one of the autonomous systems AS4, AS5, AS6 and AS7 and AS2 or AS3 and are combined progressively to form larger aggregates. The autonomous system AS2 has combined the two reservations F1 and F2 from the autonomous system AS4 and the autonomous system AS5 respectively to form the aggregate A1 in direction AS1. Similarly, the autonomous system AS3 has combined the two reservations F3 and F4 from the autonomous system AS6 and the autonomous system AS7 respectively to form aggregate A2. The autonomous system AS1 has combined the two aggregates A1 and A2 again to form a bigger aggregate A12. Based on the reservations F1, F2, F3 and F4 there thus arises a tree-like system of reservations, hereinafter called reservation tree. Each of the autonomous systems AS4, AS5, AS6 and AS7 uses its reservation F1, F2, F3 or F4 for the entire QoS traffic with destination addresses having the prefix 10.10.10.0/23.

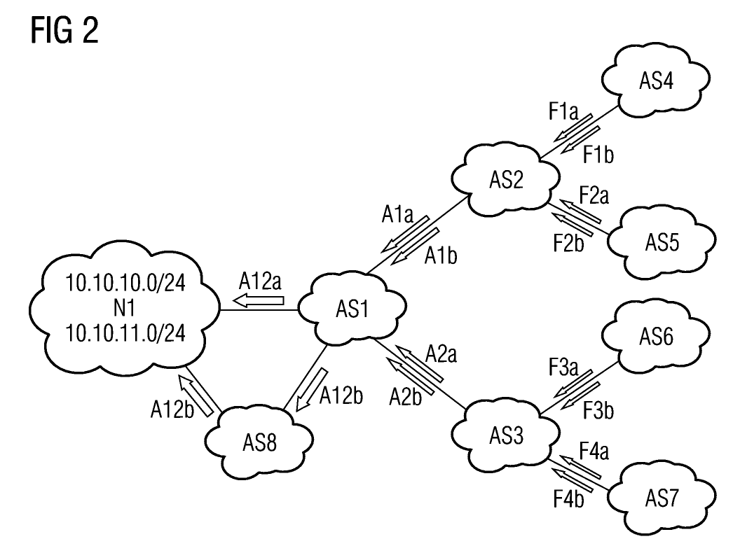

In this example it is presumed that the QoS traffic load on the direct link between AS1 and the destination network N1 exceeds a limit set by the network management and, therefore, a part of the aggregate A12 must be routed to the destination network via AS8. To this end, the prefix 10.10.10.0/23 is split into the two prefixes 10.10.10.0/24 and 10.10.11.0/24, as shown in FIG. 2, and corresponding routing messages are forwarded via the routing protocol to all autonomous systems concerned. Thereupon, all autonomous systems (AS1-7), whose QoS traffic is a component of the aggregate A12, must adapt their reservations with respect to the prefix 10.10.11.0/23 to the new path via AS8. Via the routing protocol, at least one new route with the prefix 10.10.11.0/24 is disclosed, which route leads from the autonomous system AS1 to the network N1 via the autonomous system AS8. In this way the traffic should be shifted to this prefix from the overloaded direct link between the autonomous system AS1 and the destination network N1 to the path from the autonomous system AS1 to the destination network N1 via the autonomous system AS8. On the new route, the resource management of the autonomous system AS1 reacts and sends a message to the autonomous systems AS2 and AS3 with the request that said systems re-establish their existing reservations. In response, the autonomous systems AS2 and AS3 send a corresponding message to their neighbors, the autonomous systems AS4, AS5, AS6 and AS7. Thus these messages return in the opposite direction to the existing reservations on the reservation tree from the root to the leaves, i.e. back to the nodes at which the individual reservations begin. From there new reservations are now established. Because the routing has been modified, the autonomous system AS4 subdivides its reservation F1 into two reservations F1a and F1b corresponding to the traffic to the two prefixes 10.10.10.0/24 and 10.10.11.0/24, which are now reached via different routes. The autonomous systems AS5, AS6 and AS7 react similarly and two new reservation trees are created.

Reverse signaling on the reservation tree and renewed creation of all reservations will generate a very large number of signaling messages in the real Internet, where substantially bigger reservation trees arise.

The inventive method is presented in the following. After the prefix 10.10.10.0/23 has been split into the two prefixes 10.10.10.0/24 and 10.10.11.0/24, corresponding routing messages are forwarded via the routing protocol to all autonomous systems affected. Thereupon all autonomous systems (AS1-7), whose QoS traffic is a component of the aggregate A12, must adapt their reservations with respect to the prefix 10.10.11.0/23 to the new path via the autonomous system AS8. The autonomous system AS1 notices the modified routing at a point in time T1. Thereupon the autonomous system AS1 sends a message to all neighbors from whose reservations the aggregate A12 is constructed at the point in time T1, i.e. to the autonomous systems AS2 and AS3, which message prompts said autonomous systems to check the reservations with respect to the modified routing and to respond to the autonomous system AS1 with new reservations. According to the invention, the autonomous system AS1 then waits for the responses of the autonomous systems AS2 and AS3 who were notified and monitors the maximum response time using a timer. The autonomous system AS1 waits for four reservations, one for each of the two prefixes 10.10.10.0/24 and 10.10.11.0/24 from the autonomous system AS2 and from the autonomous system AS3 respectively. Let T2 be the point in time, at which either all the expected responses have been received or the timer has expired (the earlier of the two events). In the meantime: ΔTI=T2−T1, the autonomous system AS1 constructs two new aggregates according to the reservations being received: one aggregate for the direct link to N1 (prefix 10.10.10.0/24) and one for the path via the autonomous system AS8 (prefix 10.10.11.0/24). According to the invention during ΔT1 incoming signaling messages relating to reservations of the deaggregated aggregate A12 at the point in time T1, are no longer signaled in the direction destination. Only new reservations that are not part of the deaggregated aggregate A12 at the point in time T1 are treated as usual. The allocation of incoming reservations to the deaggregated aggregate A12 is made using a unique identifier, which was sent by the autonomous system AS1 with the deaggregation message to the autonomous systems AS2 and AS3 and is contained in the returning responses. The autonomous system AS1 does not signal the two new aggregates in direction destination network N1 until the point in time T2.

According to the invention, the autonomous systems AS2 and AS3 react as the autonomous system AS1 to the message of said system to re-establish the reservations of the aggregate A12. Not until the autonomous system AS2 has received a new reservation for each of the two prefixes 10.10.10.0/24 and 10.10.11.0/24 from AS4 and from AS5 respectively, or until a corresponding timer has expired, does the autonomous system AS2 send two reservation messages to the autonomous system AS1, one for each of the two prefixes. The autonomous system AS3 reacts analogously. If no resources are to be reserved for a prefix, then a reservation can be made using the value 0 so as not to have to wait for the timer to expire.

Taking as starting point the first signaling message with which the autonomous system AS1 triggered the reconstruction of the reservations of the aggregate A12 at the point in time T1, with the new method a total of 6+12 signaling messages are required (6 to deaggregate the aggregate between AS4, AS5, AS6, AS7 and AS1+12 for the reconstruction). Without the new method, 6+24 signaling messages are required. In particular, with the new method, the load of the autonomous system AS1 drops from 8 responses to 4, thus even in this small example, the loading is halved.

It is expedient to match the running time of the timers to each other. Thus the autonomous system AS1 starts a timer and sends a message to the autonomous systems AS2 and AS3. The autonomous system AS2 then again starts a timer and sends a message to the autonomous systems AS4 and AS5. Assuming the autonomous system AS4 does not respond in time, then the timer of the autonomous system AS2 expires. The autonomous system AS2 sends the reservations A1a and A1b to the autonomous system AS1. If the timers of the autonomous systems AS2 and AS3 cover the same time span, then the timer of the autonomous system AS1 has already expired, thus the reservations of the autonomous system AS2 will no longer be taken into consideration for aggregation. This can be prevented if the time spans of the timers are geared to or matched to each other (the further in the tree, the shorter). This can be realized, for example, by inserting the time span of the timer into the messages between the autonomous systems. For example, the autonomous system AS1 discloses the running time of its timer to the autonomous system AS2, the autonomous system AS2 then selects a shorter running time, which allows the reservation messages to be sent before the timer of the autonomous system AS1 expires. This shorter running time of the timer takes into account the running time of the messages that are exchanged between the autonomous system AS1 and AS2.

The running time is then shorter by at least twice the running time of the messages exchanged (running time of the route modification message+running time of the message with the aggregated reservations).

1.-11. (canceled)

12. A method for the efficient adaptation of resource reservations when routes are modified in inter-domain routing, comprising:
communicating a modification of an inter-domain route requiring an adaptation of resource reservations to a first routing domain;
communicating the modification of the inter-domain route by the first routing domain to a second and a third routing domain;
signaling a resource reservation adapted according to the route modification, the signaling by the second and the third routing domains to the first routing domain in each instance;
combining, by the first routing domain, the at least the two resource reservations signaled from the second and the third routing domains; and
signaling the combined resource reservations as a resource reservation to a fourth routing domain.

13. The method as claimed in claim 1, further comprising:
starting a timer by the first routing domain after being informed of the route modification,
wherein the combining is of the resource reservations signaled before the timer expires.

14. The method as claimed in claim 13, wherein a resource reservation signaled after the timer expires is forwarded to the fourth routing domain without further delay as modification of the previous combination of resource reservations.

15. The method as claimed in claim 12, wherein the route modification starting from the first routing domain along existing inter-domain routes is communicated to the routing domains that have reserved resources for inter-domain routes going along via the first routing domain to a destination and that require an adaptation of the resource reservation according to the route modification.

16. The method as claimed in claim 12, wherein all resource reservations, affecting traffic to be transmitted along the modified route to a common destination, signaled as a result of the route modification are combined by the first routing domain.

17. The method as claimed in claim 16, wherein the destination is given by a routing domain or a network.

18. The method as claimed in claim 16,
wherein a timer is started by the first routing domain in response to the communication of the route modification, and
wherein the resource reservations signaled as a result of the route modification and which affect traffic to be transmitted along the modified route to a common destination and are transmitted to the first routing domain before the timer expires, are combined.

19. The method as claimed in claim 13, wherein a second timer is started by the second routing domain and resource reservations received before the timer expires are combined and signaled to the first routing domain.

20. The method as claimed in claim 19, wherein the running time of the timer started is determined according to the running time of the timer started by the first routing domain such that route modifications received during the running time of the second timer and combined on expiry of the second timer and signaled to the first routing domain, arrive at the first routing domain before the first timer expires.

21. The method as claimed in claim 20, wherein the determination of the running time of the second timer is made according to information transmitted by the first routing domain to the second routing domain.

22. A device for the efficient adaptation of resource reservations when routes are modified in inter-domain routing, comprising:
a receiver for receiving a modification of an inter-domain route requiring an adaptation of resource reservations;
a timer started in response to receiving the route modification; and
a transmitter for sending the modification of the inter-domain route to a plurality of further routing domains,
wherein the receiver receives a plurality of resource reservation adapted according to the route modification from at least a portion of the plurality of further routing domains prior to an expiration of the timer, and
wherein the received resource reservations are combined and the combined resource reservations are transmitted by the transmitter as a resource reservation to a second routing domain.

23. The device as claimed in claim 22, wherein a resource reservation received after the timer expires is transmitted to the second routing domain as a modification of the previous combination of resource reservations.

24. The device as claimed in claim 22, wherein at least a portion of the received resource reservations is an aggregate resource reservation that was combined by the sending routing domain.

25. A method for the efficient adaptation of resource reservations when routes are modified in inter-domain routing, comprising:
by the first routing domain:
receiving a modification of an inter-domain route requiring an adaptation of resource reservations;
communicating the modification of the inter-domain route to a plurality of further routing domains;
starting a timer in response to receiving the route modification;
receiving a plurality of resource reservation adapted according to the route modification from at least a portion of the plurality of further routing domains prior to an expiration of the timer;
combining the received resource reservations; and
sending the combined resource reservations as a resource reservation to a second routing domain.

26. The method as claimed in claim 25, wherein the plurality of resource reservations affect traffic to be transmitted along the modified route to a common destination.

27. The method as claimed in claim 25, further comprising receiving a resource reservation received after the timer expires, wherein the resource reservation is forwarded to the second routing domain without as a modification of the previous combination of resource reservations.
